(19) United States
(12) Patent Application Publication
(10) Pub. No.: US 2026/0080362 A1
(43) Pub. Date: Mar. 19, 2026

(54) ADAPTIVE VIRTUAL COLLABORATIVE ENVIRONMENT OPTIMIZATION

(71) Applicant: International Business Machines Corporation, Armonk, NY (US)

(72) Inventors: Natalie Brooks Powell, Bolingbrook, IL (US); Selvi John, Bangalore (IN); Santosh Rajashekar, Bangalore (IN); Sarbajit Kumar Rakshit, Kolkata (IN)

(21) Appl. No.: 18/886,987

(22) Filed: Sep. 16, 2024

(51) Int. Cl. G06Q 10/101; G06Q 10/0631; G06T 11/00

(52) U.S. Cl. CPC G06Q 10/101; G06Q 10/06313; G06T 11/00

(57) ABSTRACT

Techniques are described with respect to a system, method, and computer program product for dynamically optimizing virtual collaboration environments. An associated method includes analyzing a plurality of resource metrics associated with at least one participant associated with a virtual collaboration; and generating a virtual environment for the virtual collaboration based on the analysis; wherein generating the virtual environment comprises aggregating a plurality of media content associated with the virtual collaboration based on a detected modification to the virtual collaboration.

### FIELD

This disclosure relates generally to virtual, augmented, mixed, and/or extended reality computing systems and more particularly to adaptively optimizing virtual collaboration environments.

### BACKGROUND

Virtual collaborations, such as teleconferences, virtual meetings, and the like have become among the most popular means of communication. In particular, virtual collaborations have become extremely useful for various industries such as digital learning due to the fact that participants are able to be share an immersive and engaging experience while being distributed across various geographic locations.

### SUMMARY

Additional aspects and/or advantages will be set forth in part in the description which follows and, in part, will be apparent from the description, or may be learned by practice of the invention.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a collaboration optimization system environment, according to an exemplary embodiment;

FIG. 3 illustrates a block diagram of various modules associated with a collaboration resource module and a collaboration optimization module of the system FIG. 2, according to an exemplary embodiment;

FIG. 4 illustrates a customized virtual collaboration environment comprising avatars in a virtual learning setting, according to an exemplary embodiment;

FIG. 5 illustrates an optimized virtual collaboration environment depicting personalized virtual content based on resource metrics, according to an exemplary embodiment; and

FIG. 6 illustrates an exemplary flowchart depicting a method for dynamically optimizing virtual collaboration environments, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Aspects of an embodiment of the present invention disclose a method, system, and computer program product for dynamically optimizing virtual collaboration environments. In some embodiments, a computer-implemented method for dynamically optimizing virtual collaboration environments comprises analyzing a plurality of resource metrics associated with at least one participant associated with a virtual collaboration; and generating a virtual environment for the virtual collaboration based on the analysis; wherein generating the virtual environment comprises aggregating a plurality of media content associated with the virtual collaboration based on a detected modification to the virtual collaboration.

In various aspects, the invention relates to a computer program product for dynamically optimizing virtual collaboration environments, the computer program product comprising or more computer readable storage media and program instructions collectively stored on the one or more computer readable storage media, the stored program instructions comprising: program instructions to analyze a plurality of resource metrics associated with at least one participant associated with a virtual collaboration; and to program instructions to generate a virtual environment for the virtual collaboration based on the analysis; wherein the program instructions to generate the virtual environment comprises program instructions to aggregate a plurality of media content associated with the virtual collaboration based on a detected modification to the virtual collaboration.

In another aspect, the invention relates to a computer system for dynamically optimizing virtual collaboration environments, the computer system comprising: one or more processors; one or more computer-readable memories; program instructions stored on at least one of the one or more computer-readable memories for execution by at least one of the one or more processors, the program instructions comprising program instructions to analyze a plurality of resource metrics associated with at least one participant associated with a virtual collaboration; and to program instructions to generate a virtual environment for the virtual collaboration based on the analysis; wherein the program instructions to generate the virtual environment comprises program instructions to aggregate a plurality of media content associated with the virtual collaboration based on a detected modification to the virtual collaboration.

In various aspects, aggregation of collaborative content comprises distributing the aggregated media content to the modified virtual collaboration based on the analysis of the plurality of resource metrics; wherein the modified virtual collaboration comprises an optimal amount of participants based on one or more outputs of at least one machine learning model. As a result, illustrative embodiments provide a technical effect of optimizing virtual learning environments by presenting collaborative content within virtual collaboration to the optimal amount of participants while significantly reducing otherwise necessary computing resources including, but not limited to network bandwidth, computing device battery power, etc.

In various aspects, aggregation of collaborative content comprises segmenting collaborative content based on one or more extracted topics; wherein the optimal amount of participants relates to distribution of the aggregated media content corresponding to segments based on at least one resource metric of the plurality of resource metrics. As a result, illustrative embodiments provide a technical effect of optimizing presentation of collaborative content to respective participants based on analyses of user profiles.

In various aspects, generating the virtual environment further comprises generating a user profile associated with the at least one participant of the virtual collaboration; determining a level of effectiveness within the virtual collaboration for the at least participant; and ranking the one or more extracted topics based on the level of effectiveness. As a result, illustrative embodiments provide a technical effect of optimizing analytics associated with virtual collaboration participants, in which subsequent distribution of collaborative content optimized based on the determined level of effectiveness for the applicable participant of the respective collaborative content.

In various aspects, generating the virtual environment comprises utilizing one or more outputs of at least one machine learning model to determine distribution of a plurality of resources associated with one or more avatars of the virtual environment; wherein the virtual environment comprises the optimal amount of participants by redistributing a plurality of resources associated with a plurality of resource metrics and the plurality of resource metrics comprises one or more of power-source levels, network bandwidth, and computing resource availability. As a result, illustrative embodiments provide a technical effect of utilizing artificial intelligence-based mechanism to support redistribution of computing resources within a virtual collaboration in a manner that significantly reduces otherwise necessary computing resources to host the virtual collaboration in its original state.

One of the drawbacks of virtual collaborations is the demand for various resources, such as but not limited to network bandwidth, latency, power levels, etc., which may be heavily influenced by various factors associated with the applicable participants. For example, a participant functioning as a presenter may have the functionality of displaying media content for viewing by other participants of a given virtual collaboration; however, if the participant is having bandwidth issues on their end then the presentation is significantly impacted when being viewed by the other participants.

The following described exemplary embodiments provide a method, computer system, and computer program product for dynamically optimizing virtual collaboration environments. Various depths and complexities are taken into consideration when operating virtual collaborations (e.g., teleconferences, virtual meetings, and the like). In particular, virtual learning not only supports user-specific personalization, but also dynamic content rendering for the purpose of simultaneously engaging students via sensory sensations such as sight, touch, sound, and the like. However, maintaining these virtual learning environments require a significant amount of computing resources including, but not limited to network bandwidth, computing device battery power, etc. Therefore, the present embodiments have the capacity to provide a system configured to analyze resources associated with virtual collaboration participants in order to not only optimize allocation associated with a virtual collaboration (e.g., optimal number of participants, personally tailored learning content, reduce computing resources, and the like), but also aggregate entire collaborative contents from all the participants and distribute them among the reduced number of avatars representing participants ensuring that the reduction in participating users does not compromise the effectiveness of collaborative learning. Furthermore, the present embodiments have the capacity to utilize machine learning and artificial intelligence-based mechanisms to output metrics, resource-related predictions, and historical data about educational topics presented within the virtual learning environment in order to ensure effective collaborative content is delivered with optimal resource allocation.

As described here, the term “collaborative content” comprises any applicable texts, audio (e.g., audiobooks, podcasts, etc.), multi-media content, and the like configured to be distributed within a collaborative environment, in which the collaborative environment comprises any one or more users engaged in a telecommunications session.

As described here, the term “resources” comprises any applicable feature associated with rendering, allocating, and/or sustaining video/audio communications, web-based communications, and collaborative content within a collaborative environment including, but not limited to network bandwidth, battery power levels, computational load balancing, latency, phasing, dynamic content modification, and any other applicable computing resources known to those of ordinary skill in the art.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

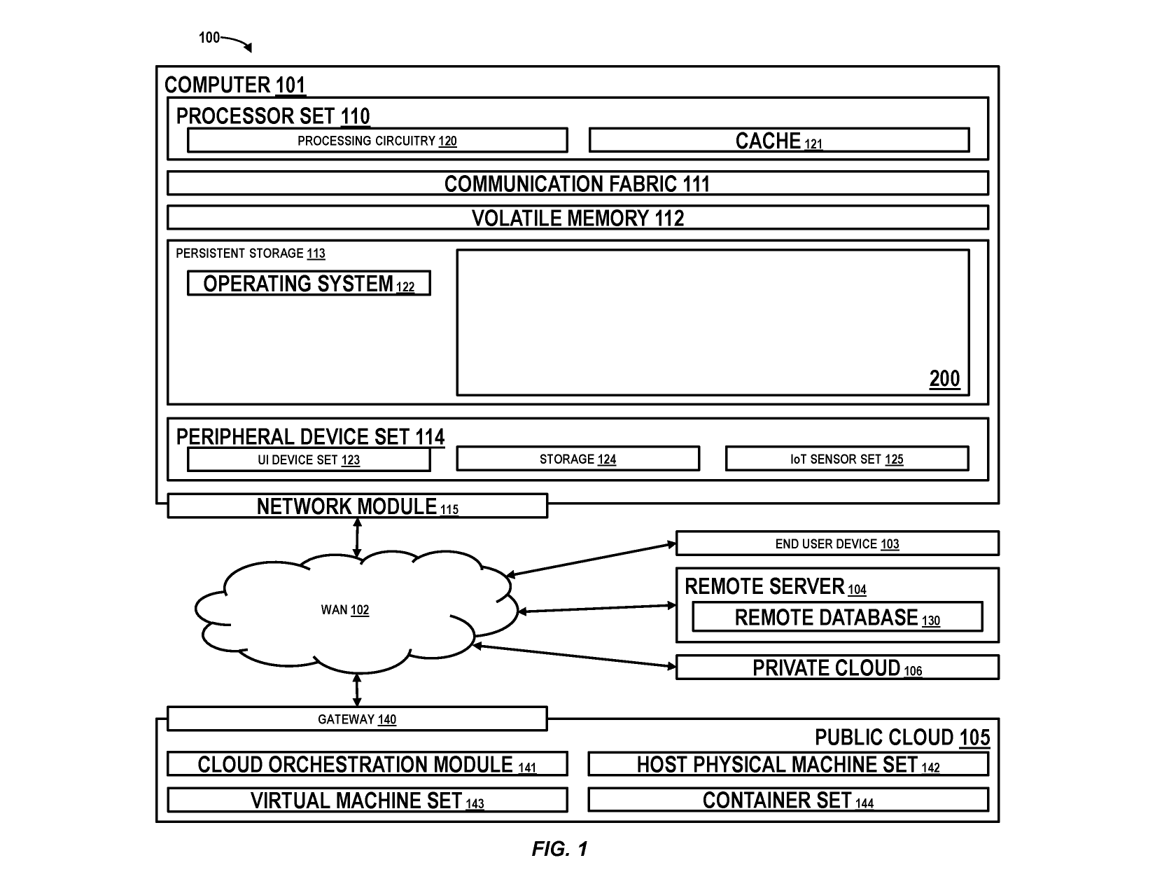

The following described exemplary embodiments provide a system, method, and computer program product for dynamically optimizing virtual collaboration environments. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Furthermore, computing environment 100 contains an example of an environment for the execution of at least some of the computer code involved in performing the inventive methods, such as but not limited to improved cloud orchestration code, new ML algorithm code, etc. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

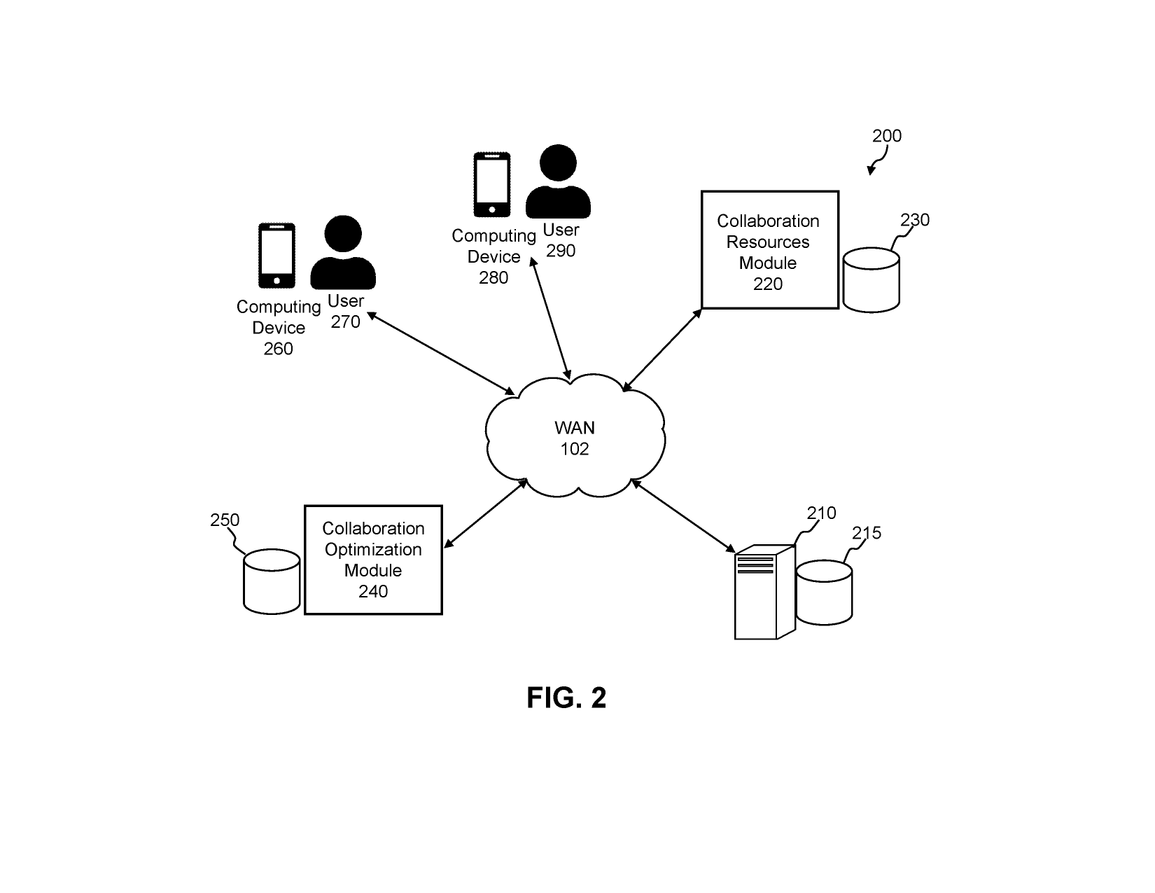

Referring now to FIG. 2, a functional block diagram of a networked computer environment illustrating a computing environment for a collaboration optimization system 200 (hereinafter “system”) comprising a server 210 communicatively coupled to a database 215, a collaboration resources module 220 communicatively coupled to a collaboration resources module database 230, a collaboration optimization module 240 communicatively coupled to a collaboration optimization module database 250, a first computing device 260 associated with a first user 270, and a second computing device 280 associated with a second user 290, each of which are communicatively coupled over WAN 102 (hereinafter “network”) and data from the components of system 200 transmitted across the network is stored in database 215.

In some embodiments, server 210 is configured to operate a centralized platform serving as a cloud-based collaborative content management platform. server 210 is configured to provide mechanisms for users 270 and 290 to not only view metrics, analytics, and the like associated with virtual collaborations and collaborative content distributed within, but also provide information from various internet-based sources to collaboration resources module 220 and collaboration optimization module 240 for various purposes. For example, user profiles associated with user 270 and 290 may be generated by collaboration resources module 220 in order to ascertain levels of engagement with collaborative content, resource optimization, etc. based on data provided by server 210. In some embodiments, server 210 may utilize one or more web crawlers to ascertain data from various internet-based sources relevant to users 270 and 290 including, but not limited to social networking sites, blog sites, and any other applicable internet-based data sources known to those of ordinary skill in the art.

Collaboration resources module 220 is tasked with analyzing virtual environments comprising collaborative content and generating user profiles associated with users 270 and 290, but also ascertaining metrics associated with computing devices 260 and 280 and/or users 270 and 290 for the purpose of improving virtual collaborations by optimizing resource allocation. In some embodiments, the user profiles may comprise contextual information associated with the virtual collaboration, users 270 and 290, along with metrics derived from user activity of users 270 and 290 within virtual environments and virtual collaborations. The metrics may include but are not limited to, engagement levels within virtual collaboration, user interaction data acquired by computing devices 260 and 280 (e.g., gaze detection, focus on a particular virtual object exceeding a threshold amount of time, a predetermined amount of time spent on a particular collaborative content, and the like), topics relevant to the interests of users 270 and 290, and the like. Metrics of virtual collaboration participants may include, but are not limited to power supply of applicable computing device(s), network bandwidth, latency, dynamic modifications of collaborative content (e.g., phasing, segmenting, aggregating, etc.), and any other applicable virtual collaboration metrics known to those of ordinary skill in the art. It should be noted that the metrics are utilized by collaboration optimization module 240 along with other applicable data in order for one or more machine learning models to generate outputs representing predictions of one or more of optimal number of participants for virtual collaboration, bandwidth allocation, latency reduction, battery power preservation, battery power consumption, and the like. Furthermore, collaboration resources module 220 is configured to analyze virtual collaborations in order to ascertain information relating to virtual environment designs, virtual elements (e.g., virtual objects, avatars, chatbots, etc.), context (e.g., discussions, topics, moments of contention among participants, etc.), collaborative content, virtual interactions, and any other ascertainable information associated with virtual environments known to those of ordinary skill in the art.

Collaboration optimization module 240 is tasked with not only adaptively aggregating collaborative content of virtual collaborations for the purpose of redistributing the aggregated collaborative content to ultimately reduce the number participants ensuring no compromise in the collaborative learning effectiveness and content, but also utilizing the aforementioned outputs of the machine learning models to adjust the amount of participants based on metrics in order optimize virtual collaborations. In some embodiments, collaboration optimization module 240 is configured to personalize virtual environments with distinct visual designs and optimal participant numbers for users 270 and 290; thus, delivering uniform collaborative content without latency differences. The personalization of virtual environments is achieved by dynamically adjusting the number of participating avatars and visual designs based on each participant's available resources such as network bandwidth, battery power, and computing resources. For example, in cases where a participant has limited resources, the system may phase out certain visual elements or reduce the number of avatars rendered in their environment. This phasing allows the participant to experience the same educational content as others, without latency, by ensuring that their environment is optimized for their specific device capabilities. Furthermore, collaboration optimization module 240 comprises latent semantic analysis techniques via natural language processing, computer vision, image analysis, topic identification, virtual object recognition, setting/environment classification, and any other applicable artificial intelligence and/or cognitive-based techniques known to those of ordinary skill in the art in order to ascertain contextual information in order to perform segmentation of educational topics into subsegments. In some embodiments, collaboration optimization module 240 performs correlation and ranking of collaborative content based on historical data derived from the user profiles and/or analyses of virtual environments. It should be noted that one of the purposes of aggregating and ranking collaborative content from all virtual collaboration participants is to support distribution among a determined optimal amount of virtual collaboration participants ensuring that the reduction of participants does not compromise the effectiveness of virtual environment. In some embodiments, the optimal number of participants is determined based on historical data and real-time analysis of the virtual session. For example, if a collaborative session is found to be most effective with 5 to 7 participants due to their ability to engage in meaningful interaction without overwhelming the session, the system will optimize the environment to accommodate this range. The aggregation and ranking process involves collecting inputs from all participants and then redistributing these inputs to the reduced number of avatars to maintain engagement and effectiveness. This ensures that even if the number of active avatars is reduced, the quality of interaction and collaborative learning is maintained. Computing devices 260 and 280 may take the form of a desktop computer, laptop computer, tablet computer, smart phone, smart watch or other wearable computer, mainframe computer, computer-mediated reality (CMR) device/ VR device, quantum computer or any other form of computer or mobile device now known or to be developed in the future that is capable of running a program, accessing a network or querying a database. It should be noted that in the instance in which computing devices 260 and 280 are CMR devices (e.g., VR headset, AR goggles, smart glasses, etc.) or other applicable wearable device, computing devices 260 and 280 are configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IOT”) sensors, or any other applicable type of sensors known to those of ordinary skill in the art.

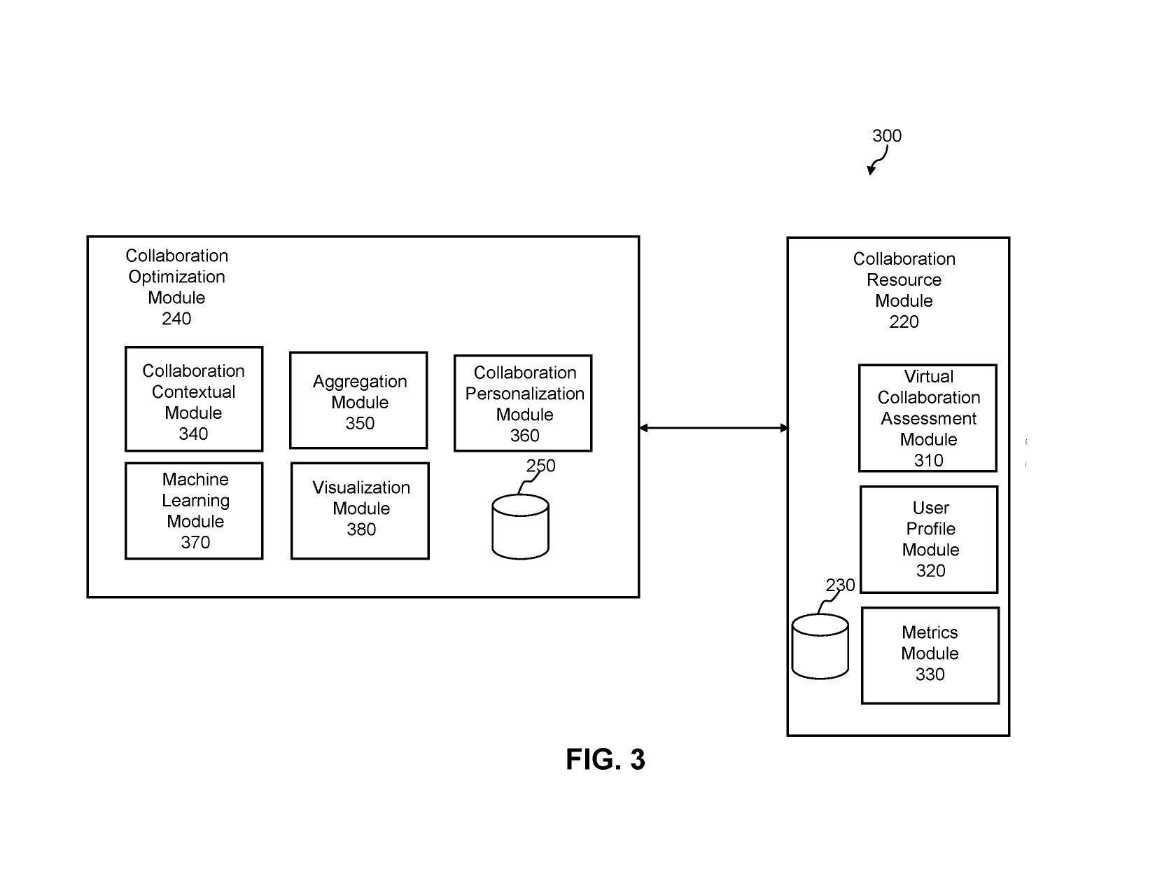

Referring now to FIG. 3, an example architecture 300 of collaboration resources module 220 and collaboration optimization module 240 is depicted, according to an exemplary embodiment. In some embodiment, collaboration resources module 220 comprises a collaboration assessment module 310, a user profile module 320, and a metrics module 330. Collaboration optimization module 240 comprises a collaboration contextual module 340, an aggregation module 350, a collaboration personalization module 360, a machine learning module 370, and a visualization module 380. Outputs of one or more machine learning models operated by machine learning module 370 are configured to be stored in one or more of database 215, collaboration resources module database 230, and collaboration optimization module database 250, in which the machine learning models may train datasets based on data derived from one or more of server 210, collaboration resources module 220, collaboration optimization module 240, and any other applicable data sources (e.g., internet-based data sources).

Collaboration assessment module 310 is tasked with analyzing virtual environments and other applicable infrastructures comprising virtual collaborations for the purpose of ascertaining relevant data pertaining to virtual elements associated with virtual collaborations. It should be noted that virtual elements may include, but is not limited to virtual objects, chatbots, virtual environment designs, collaborative content presentation (e.g., visualizations, user preferences, triggering virtual interactions, etc.), collaborative content, and the like. Collaboration assessment module 310 supports computer vision, Convolutional Neural Networks (CNNs) for object detection and segmentation, natural language processing (NLP), Natural Language Understanding (NLU), image analysis, topic identification, virtual object recognition, setting/environment classification, and any other applicable artificial intelligence and/or cognitive-based techniques known to those of ordinary skill in the art. For example, collaboration assessment module 310 may utilize one or more of the aforementioned techniques in order to perform functionalities such as Named Entity Recognition (NER) and sentiment analyses in order to identify and categorize virtual objects within the applicable virtual environment(s) based on data volumes associated with each virtual object stored in collaboration resources module database 230. Furthermore, collaboration assessment module 310 may distinguish between static and dynamic virtual objects within the applicable virtual environment. As a result, virtual objects that typically require more computing resources for rendering, such as avatars, are classified as dynamic and accessed within collaboration resources module database 230 via virtual object pointers. Computing resources otherwise needed to render avatars are reduced by collaboration assessment module 310 referencing the virtual object pointers. In some embodiments, collaboration assessment module 310 communicates with machine learning module 370 in order to utilize one or more machine learning models to output network bandwidth, batter power, and computing resource usage predictions for a virtual collaboration based on historical data associated with previous virtual collaborations. For example, collaboration assessment module 310 may utilize clustering techniques in order to categorize virtual objects, in which virtual object categorization may be based on one or more metrics generated by metrics module 330, contextual information ascertained by collaboration contextual module 340, user profiles, and the like. For example, metrics may allow collaboration assessment module 310 to categorize virtual objects based on the amount of complexity and resource intensity necessary to render the applicable virtual object. Based on the categorization, machine learning module 370 may accurately estimate power and network requirements.

User profile module 320 is designed to generate and maintain user profiles associated with users 270 and 290. It should be noted that the user profiles may comprise data ascertained from one or more of server 210, computing devices 260 and 280, collaboration resources module database 230, and collaboration optimization module database 250. For example, user profiles may comprise data relating to social media activity, preferences of users 270 and 290, interests of users 270 and 290, and the like. In some embodiments, analytics associated with users 270 and 290 within virtual collaborations may be accounted for in the user profiles including, but not limited to level of engagement with collaborative content, most frequently discussed educational topics, and any other applicable analytics associated with virtual collaborations known to those of ordinary skill in the art. In some embodiments, user profiles are utilized by collaboration personalization module 360 in order to not only help identify if personalization is necessary for resource optimization purposes, but also assist with generating personalized learning environments tailored to users 270 and 290, respectively. For example, virtual objects necessary for user 270 to effectively engage with collaborative content may differ from those desired by user 270; thus, virtual elements may be removed based on the applicable user profile in order to optimize utilization of computing resources ultimately improving the virtual collaboration in seamless manner.

Metrics module 330 is tasked with generating and managing metrics associated with computing devices 260 and 280, respectively. Due to the varying infrastructures that are network and computing device specific, metrics module 330 generates metrics based upon various factors including, but not limited to respective cloud resources, applicable collaborative content, duration of applicable collaborative content, virtual element/object deployment (e.g., applicable avatars, chatbots, etc.), number of participants of the applicable virtual collaboration, and the like. In some embodiments, metrics module 330 communicates with machine learning module 370 in order to ascertain metrics of various resources associated with users 270 and 290 that are outside of an expected range and/or anomalies associated with collaborative content that requires more bandwidth and/or computing resources than usual. Therefore, metrics module 330 is able to utilize machine learning module 370 to generate one or more models configured to classify resources associated with a virtual collaboration as operating normally and/or abnormally in real-time based on utilizing patterns that machine learning module 370 identify in historical data. Furthermore, metrics module 330 may obtain historical data associated with virtual collaborations and/or collaborative content to ascertain consumption metrics in which machine learning module 370 performs classification and/or clustering to determine resource consumption analytics of collaborative content. Various attributes of the collaborative content (e.g., features, patterns, components, etc.) may be ascertained by metrics module 330 and subsequent correlation to resource types is within the scope of the disclosure as well. The metrics support machine learning module 370 with classifying virtual elements and object into categories such as but not limited to low, medium, and high resource-demanding objects along with identify ranges of power consumption, network bandwidth, and resource allocation. For example, factors such as screen brightness, rendering complexity, sensor usage, and the like may impact the virtual collaboration, in which collaboration personalization module 360 utilizes the aforementioned metrics in order modify collaborative content and/or determine an optimal amount of participants associated with the applicable virtual collaboration in order to deliver collaborative content uniformly in the virtual environment without latency differences.

Collaboration contextual module 340 is tasked with ascertaining contextual information associated with one or more of users 270 and 290, computing devices 260 and 280, collaborative content, the applicable virtual collaboration, and the applicable virtual environment. It should be noted that one of the purpose collaboration contextual module 340 is to monitor virtual collaboration participants’ interactions with collaborative content for feedback loop purposes. For example, the level of comfort of user 270 or the amount of benefit associated with a particular collaborative content (e.g., interactive chatbot avatar, etc.) may be ascertained and subsequently used when determining whether it is necessary to render a particular virtual object associated with the collaborative content. Collaboration contextual module 340 communicates with aggregation module 350 tasked with performing segmentation of collaborative content, in which the segmentation supports collaboration contextual module 340 with identifying and monitoring effectiveness of collaborative content for participants and ranks the respective collaborative content accordingly. In some embodiments, the ranking feature functions by analyzing participant interactions and the relevance of the collaborative content. For example, if during a session, certain topics consistently generate high levels of engagement and positive feedback, these topics will be ranked higher in terms of their effectiveness. The system might assign a higher priority to content that is frequently discussed, resulting in these topics being highlighted or focused on more in subsequent sessions. This ranking helps to streamline content delivery, ensuring that the most impactful topics are emphasized.

Aggregation module 350 is tasked with not only segmenting collaborative content, but also adaptively aggregating collaborative content for the purpose of ensuring no compromise in collaborative learning effectiveness and content once redistributed to the determined optimal number of participants. Segmentation of collaborative content is accomplished by utilizing one or more segmentation algorithms based on the number of participants in each VR educational room to allocate segmented conversation contents to individual participating avatars in the virtual environment for delivery, in which segmentation algorithms used in this context include but are not limited to clustering algorithms like K-means or hierarchical clustering, which can group participants based on their interaction patterns and the complexity of the educational content. For instance, the system might use these algorithms to segment a discussion topic into subtopics, allocating each subtopic to different avatars based on the participants’ engagement levels. Another example is the use of decision trees or random forests to decide how content should be divided and delivered to ensure the most efficient use of resources. Furthermore, aggregation module 350 may identify each and every participant who have joined a virtual collaboration to ascertain dialogues, topics, points of contention, and the like relating to the virtual collaboration, in which the virtual collaboration may be portioned into subsets each partition comprising participants. In some embodiments, segmenting may be based on topics extracted from the collaborative content associated with a virtual collaboration. Upon collaboration personalization module determining how the virtual collaboration is to be partitioned, aggregation module 350 segments collaborative content based upon the number of participants associated with each partition and aggregates collaborative content for distribution across the partitions. Thus, although users 270 and 290 may be participants of the same virtual collaboration, they may have completely different experiences due to being allocated to distinct partitions and distributed aggregated collaborative content based on one or more of ascertained metrics, analyses of respective user profiles, and the like. Aggregation module 350 supports taking aggregated collaborative content from the entire session, segmenting it into smaller parts (e.g., different discussion threads), and then assigning these segments to specific avatars within the virtual environment. For example, if there are five avatars present, each might be responsible for leading a discussion on a particular subtopic. This allows for the content to be more easily digested by participants as each avatar delivers a focused portion of the conversation; thus, reducing otherwise required computing resources for unaggregated collaborative content. In some embodiments, aggregation module 350 communicates with machine learning module 370 in order to perform clustering of collaborative content in order to categorize virtual elements based on complexity and resource intensity allowing power and network requirements to be estimated accurately. Subsequently, aggregated content may be distributed based on the previously determined optimal number of participants in a virtual collaboration.

Collaboration personalization module 360 is tasked with rendering personalized collaborative content tailored for users 270 and 290, respectively. In some embodiments, collaboration personalization module 360 ascertains available battery power of computing devices 260 and 280, along with analyzes applicable metrics in order to determine whether additional computation is required while rending the personalized educational content (e.g., locally executing Generative Adversarial Networks on computing devices 260 and 280). During this process, collaboration personalization module 360 is also analyzing the user profiles in order to determine if rendering of collaborative content is necessary and/or if removal of relevant virtual elements is warranted based on the available resources and participant preferences; thus, not only allowing battery power availability, network bandwidth, computing resources, and the like to be ascertained for where in the virtual collaboration the participant will join in, but also allowing identification of the collaborative content based on how much resource is required for delivering the educational content. In some embodiments, collaboration personalization module 360 may utilize the remaining available resources for generating and deploying participating avatars within the applicable environment for users 270 and 290 to engage with. The purpose of deploying participating avatars is to maintain engagement and interaction within the virtual environment. By generating avatars that participants can engage with, the system ensures that even if the number of real participants is reduced due to resource constraints, the interaction remains dynamic and the educational experience is not compromised. This helps in creating a consistent and immersive learning environment where the avatars represent active participants. Furthermore, collaboration personalization module 360 is configured to identify each and every participant who has joined in the virtual collaboration (i.e., educational session), in which each and every participant is identified individually for the purpose of both ascertaining resource consumption and dictating personalization of collaborative content.

Machine learning module 370 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. For example, machine learning module 350 is designed to maintain one or more machine learning models dealing with training datasets including data derived from database 215, collaboration resources module database 230, and collaboration optimization module database 250, in which the one or more machine learning models generate outputs representing predictions relating to resource requirements/consumption of collaborative content, optimal number of participants for virtual collaboration, and/or virtual elements that may be removed based on historical information.

Visualization module 380 is tasked with rendering personalize collaborative content and depicting said content within the applicable virtual environment. It should be noted that the collaborative content is rendered and visualized based on the amount of available resources for educational content and/or virtual collaboration. Due to the fact that participants will have varying resource availability, visualization module 380 takes into consideration the determined optimal number of participants in order to optimize resource utilization in designing and tailoring the applicable virtual environment in a personalized manner. For example, the respective battery power of computing devices 260 and 280 along with analytics of users 270 and 290 are likely to be distinct, in which visualization module 380 must simultaneously redistribute collaborative content in an aggregated and personalized manner in order for the virtual collaboration to be seamless and scalable. Furthermore, distribution of the collaborative content is aggregated and based one or more modifications to the virtual collaboration ascertained from analyses of the metrics. Visualization module 380 may communicate with machine learning module 370 in order to utilize one or more generative adversarial networks (GANs) for designing the virtual environment and tailoring the collaborative content for users 270 and 290, respectively. When using GANs for designing the virtual environment and tailoring the collaborative content, GANs can create realistic and diverse virtual settings that adapt to different learning scenarios. For example, GANs could generate varying virtual landscapes or classrooms that align with the educational content, thereby enhancing the immersive experience. Additionally, the use of GANs can be highlighted in the context of real-time adjustments, where the environment can evolve based on participant interactions, ensuring a dynamic and responsive learning atmosphere.

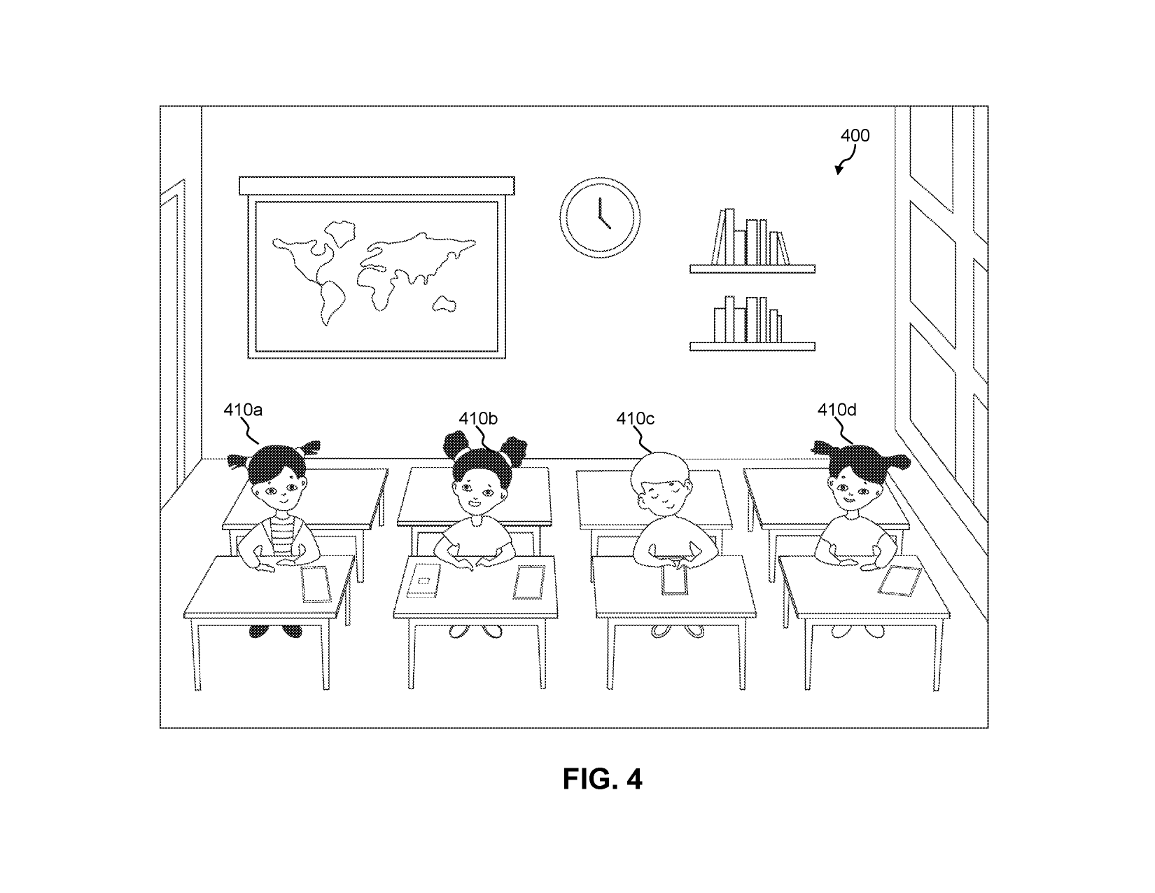

Referring now to FIG. 4, a customized virtual collaboration environment 400 is depicted, according to an exemplary embodiment. Customized virtual collaboration environment 400 is generated by visualization module 380, in which computing device 260 or 280 depicts the perspective of user 270 or 290 who operate within the digital space as avatars. Participating avatars 410a-d may be one or more of participants in the virtual collaboration, avatars rendered from remaining available resources, virtual chat-bots, and the like. It should be noted that customized virtual collaboration environment 400 is tailored specifically for user 270 or 290 based on analyses of metrics, the applicable user profile, historical information relating to virtual collaboration, collaborative content analytics (e.g., engagement, responses, feedback, etc.), and the like. For example, a first customized virtual collaboration associated with user 270 may comprise participating avatars 410a-d; however, a second customized virtual collaboration associated with user 290 may not comprise all of participating avatars 410a-d because of the available resources associated with computing device 280 and/or historical information indicating that user 290 does not like to engage with other participants; therefore, collaboration personalization module 360 removes one or more participating avatars 410a-d. In another example, a level of effectiveness of the collaborative content for a particular user may be ascertained from the feedback loop for the purpose of ranking one or more extracted topics of collaborative content based on the level of effectiveness.

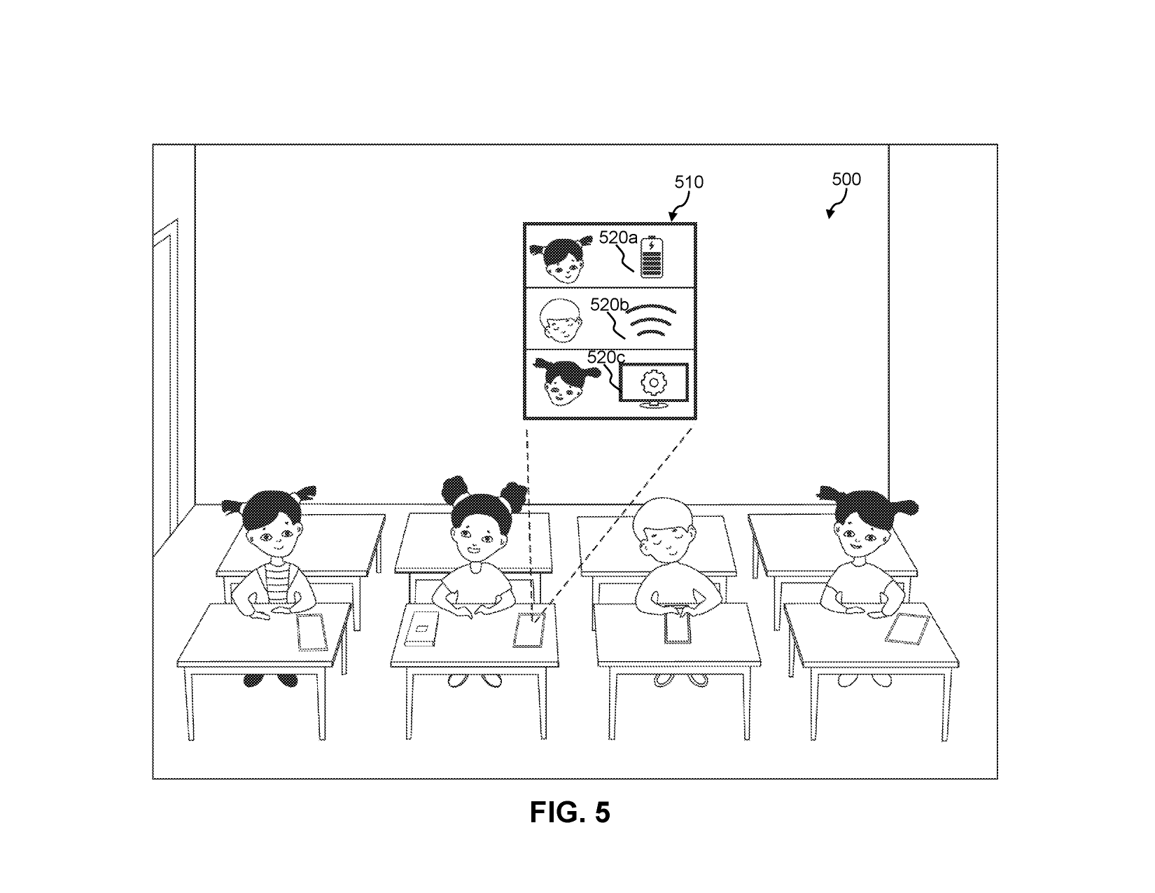

Referring now to FIG. 5, an optimized virtual collaboration environment 500 is depicted to computing device 260, according to an exemplary embodiment. Optimized virtual collaboration environment 500 illustrates resource metrics 510 associated with other participants of the virtual collaboration; however, resource metrics 510 may relate to the amount of resources a virtual element, participant, or applicable computing device may consume. In some embodiments, resource metrics are privatized in a manner allowing each respective participant to view only their own metrics; however, in instances in which resources metrics are not privatized users 270 and 290 are able to ascertain an applicable source that is causing disruption to the virtual collaboration (e.g., latency, low/bad connection, etc.). Resource metrics 510 may also be useful for participants to determine various factors associated with maintaining an optimal virtual collaboration such as but not limited to whether the benefits of a particular collaborative content outweigh the burdens in light of virtual collaboration usefulness and resource consumption demands. Optimized virtual collaboration environment 500 comprises the re-allocated and distributed aggregated collaborative content, in which visualization module 380 generates optimized virtual collaboration environment 500 based on a detected modification to the virtual collaboration including, but not limited to change to collaborative content, adjustment of amount of participants, user-based virtual interactions, allocation of computing resources, change of computing device battery power source, and the like.

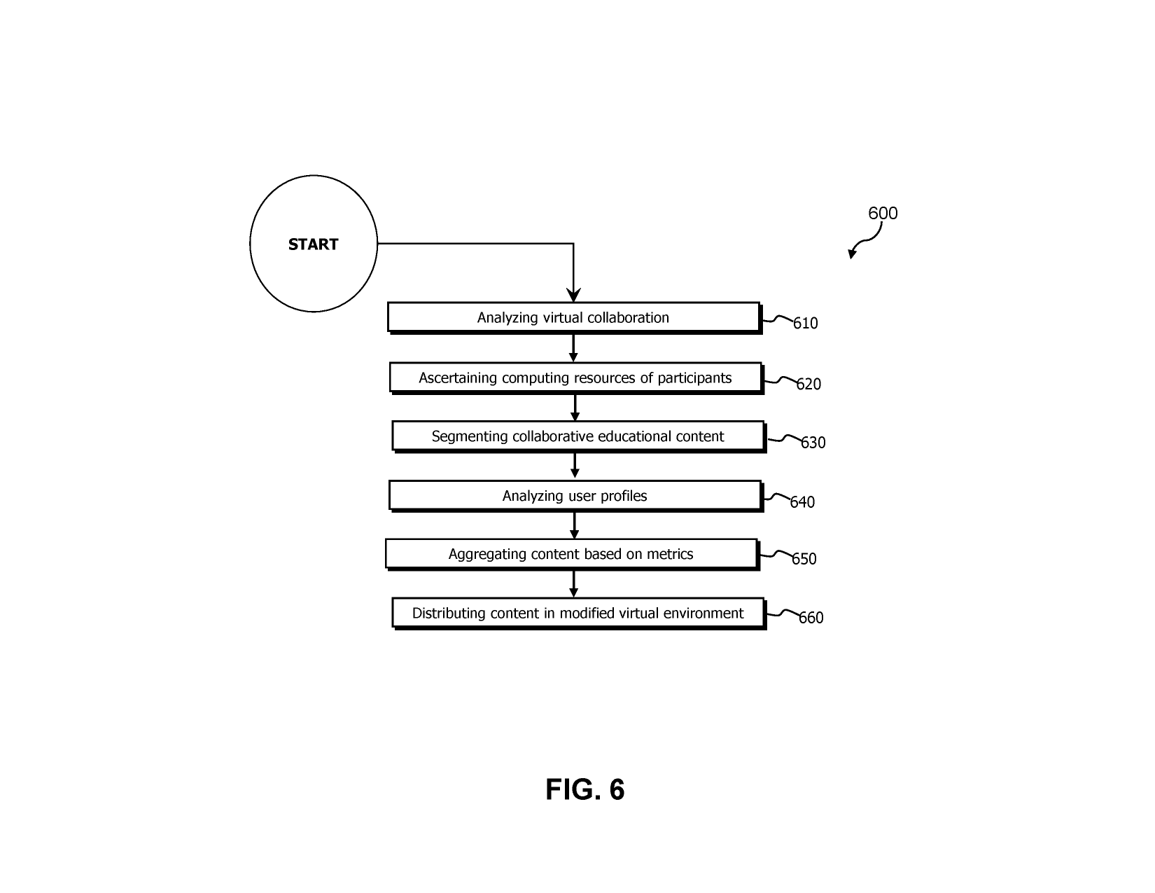

With the foregoing overview of the example architecture, it may be helpful now to consider a high-level discussion of an example process. FIG. 6 depicts a flowchart illustrating a computer-implemented process 600 for dynamically optimizing virtual collaboration environments, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, collaboration assessment module 310 analyzes a virtual collaboration. In some embodiments, collaboration assessment module 310 may utilize one or more of computer vision, Convolutional Neural Networks (CNNs) for object detection and segmentation, natural language processing (NLP), Natural Language Understanding (NLU), image analysis, topic identification, virtual object recognition, setting/environment classification, and any other applicable artificial intelligence and/or cognitive-based techniques known to those of ordinary skill in the art in order to perform analyses on the virtual collaboration. As a result of analyzing the virtual collaboration various information may be ascertained such as, but not limited to contextual information, dialogue topics/subjects, participant-specific analytics (e.g., preferences, activity patterns, etc.), time-series data, and any other applicable information configured to be ascertained from virtual collaborations/ telecommunication sessions.

collaboration assessment module 310

At step 620 of process 600, metrics module 330 ascertains information relating resources associated with participants of the virtual collaboration. Resources may include but is not limited to network bandwidth, computing device battery power, applicable avatar requirements, resources relevant to computing device 260, and the like. One of the primary purposes of acquiring information relating to the resources is to determine the amount of computing resources required to sustain the virtual collaboration for each participant of the virtual collaboration as preferences and requirements may vary for each participant.

At step 630 of process 600, aggregation module 350 performs segmentation of the collaborative content of the virtual collaboration. In some embodiments, segmentation of collaborative content is accomplished by utilizing one or more segmentation algorithms based on the number of participants in each VR educational room to allocate segmented conversation contents to individual participating avatars in the virtual environment for delivery, in which segmentation algorithms used in this context include but are not limited to clustering algorithms like K-means or hierarchical clustering, which can group participants based on their interaction patterns and the complexity of the educational content. Segmentation may also be based on various factors including but not limited to relevant contextual information, topic of dialogue, resource availability, user preferences, virtual collaboration platform requirements, and any other applicable segmentation factors known to those of ordinary skill in the art.

At step 640 of process 600, user profile module 320 performs analyses on the respective user profiles associated with participants of the virtual collaboration. In addition to user preferences, analytics, and the like being ascertained for virtual collaboration participants, analyses of the user profiles allows for collaboration optimization module 240 to determine in what ways a virtual collaboration may be optimized overall, and more importantly at a participant level. Optimization of the virtual collaboration may comprise optimization of resource utilization, collaborative content distribution, virtual object/element manipulation, virtual environment modification, and the like.

At step 650 of process 600, aggregation module 350 performs aggregation of collaborative content. It should be noted that one of the purposes of aggregating and ranking collaborative content from all virtual collaboration participants is to support distribution among a determined optimal amount of virtual collaboration participants ensuring that the reduction of participants does not compromise the effectiveness of virtual environment. However, aggregation of the collaborative content may be based on one or more of contextual information, analyses of profiles, outputs of the one or more machine learning models, resource metrics, and the like.

At step 660 of process 600, visualization module 380 visualizes modified collaborative content within the virtual environment associated with the virtual collaboration. It should be noted that the visualization comprises the redistribution of the collaborative content based on one or more of the aforementioned aggregation, ranking, segmentation, etc. Visualization module 380 may communicate with machine learning module 370 in order to utilize one or more generative adversarial networks (GANs) for designing the virtual environment and tailoring the collaborative content for participants. Visualization module 380 creates realistic and diverse virtual settings that adapt to different learning scenarios which may be manifested within the virtual collaboration overall and/or in a participant-specific manner. In some embodiments, visualization module 380 visualizes modifications to the collaborative content comprising varying virtual landscapes or classrooms that align with the topics of the associated dialogues, thereby enhancing the immersive experience. Additionally, the use of GANs can be highlighted in the context of real-time adjustments, where the environment can evolve based on metrics, analyses of user profiles, participant interactions, and the like; thus, ensuring a dynamic and responsive learning atmosphere.

Based on the foregoing, a method, system, and computer program product have been disclosed. However, numerous modifications and substitutions can be made without deviating from the scope of the present invention. Therefore, the present invention has been disclosed by way of example and not limitation.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for dynamically optimizing virtual collaboration environments, the method comprising:
analyzing, by a computing device, a plurality of resource metrics associated with at least one participant associated with a virtual collaboration; and
generating, by the computing device, a virtual environment for the virtual collaboration based on the analysis;
wherein generating the virtual environment comprises aggregating, by the computing device, a plurality of media content associated with the virtual collaboration based on a detected modification to the virtual collaboration.

2. The computer-implemented method of claim 1, wherein aggregating the plurality of media content further comprises:
distributing, by the computing device, the aggregated media content to the modified virtual collaboration based on the analysis of the plurality of resource metrics;
wherein the modified virtual collaboration comprises an optimal amount of participants based on one or more outputs of at least one machine learning model.

3. The computer-implemented method of claim 2, wherein aggregating the plurality of media content further comprises:
segmenting, by the computing device, the plurality of media content based on one or more extracted topics;
wherein the optimal amount of participants relates to distribution of the aggregated media content corresponding to segments based on at least one resource metric of the plurality of resource metrics.

4. The computer-implemented method of claim 1, wherein the plurality of resource metrics comprise one or more of power-source levels, network bandwidth, and computing resource availability.

5. The computer-implemented method of claim 1, wherein generating the virtual environment further comprises:
generating, by the computing device, a user profile associated with the at least one participant of the virtual collaboration;
determining, by the computing device, a level of effectiveness of the plurality of media content within the virtual collaboration for the at least participant; and
ranking, by the computing device, the one or more extracted topics based on the level of effectiveness.

6. The computer-implemented method of claim 2, wherein the virtual environment comprises the optimal amount of participants by redistributing a plurality of resources associated with the plurality of resource metrics.

7. The computer-implemented method of claim 1, wherein generating the virtual environment further comprises:
utilizing one or more outputs of at least one machine learning model to determine distribution of a plurality of resources associated with one or more avatars of the virtual environment representing one or more participants of the virtual collaboration.

8. A computer program product for dynamically optimizing virtual collaboration environments, the computer program product comprising one or more computer readable storage media and program instructions collectively stored on the one or more computer readable storage media, the stored program instructions comprising:
program instructions to analyze a plurality of resource metrics associated with at least one participant associated with a virtual collaboration; and
program instructions to generate a virtual environment for the virtual collaboration based on the analysis;
wherein the program instructions to generate the virtual environment comprise program instructions to aggregate a plurality of media content associated with the virtual collaboration based on a detected modification to the virtual collaboration.

9. The computer program product of claim 8, wherein program instructions to aggregate the plurality of media content further comprise:
program instructions to distribute the aggregated media content to the modified virtual collaboration based on the analysis of the plurality of resource metrics;
wherein the modified virtual collaboration comprises an optimal amount of participants based on one or more outputs of at least one machine learning model.

10. The computer program product of claim 9, wherein the program instruction to aggregate the plurality of media content further comprise:
program instructions to segment the plurality of media content based on one or more extracted topics;
wherein the optimal amount of participants relates to distribution of the aggregated media content corresponding to segments based on at least one resource metric of the plurality of resource metrics.

11. The computer program product of claim 8, wherein the plurality of resource metrics comprise one or more of power-source levels, network bandwidth, and computing resource availability.

12. The computer program product of claim 8, wherein the program instructions to generate the virtual environment further comprise:
program instructions to generate a user profile associated with the at least one participant of the virtual collaboration;
program instructions to determine a level of effectiveness of the plurality of media content within the virtual collaboration for the at least participant; and
program instructions to rank the one or more extracted topics based on the level of effectiveness.

13. The computer program product of claim 9, wherein the virtual environment comprises the optimal amount of participants by redistributing a plurality of resources associated with the plurality of resource metrics.

14. The computer program product of claim 8, wherein the program instructions to generate the virtual environment further comprise:
program instructions to utilize one or more outputs of at least one machine learning model to determine distribution of a plurality of resources associated with one or more avatars of the virtual environment representing one or more participants of the virtual collaboration.

15. A computer system for dynamically optimizing virtual collaboration environments, the computer system comprising:
one or more processors;
one or more computer-readable memories;
program instructions stored on at least one of the one or more computer-readable memories for execution by at least one of the one or more processors, the program instructions comprising:
program instructions to analyze a plurality of resource metrics associated with at least one participant associated with a virtual collaboration; and
program instructions to generate a virtual environment for the virtual collaboration based on the analysis;
wherein the program instructions to generate the virtual environment comprise program instructions to aggregate a plurality of media content associated with the virtual collaboration based on a detected modification to the virtual collaboration.

16. The computer system of claim 15, wherein program instructions to aggregate the plurality of media content further comprise:
program instructions to distribute the aggregated media content to the modified virtual collaboration based on the analysis of the plurality of resource metrics;
wherein the modified virtual collaboration comprises an optimal amount of participants based on one or more outputs of at least one machine learning model.

17. The computer system of claim 16, wherein the program instruction to aggregate the plurality of media content further comprise:
program instructions to segment the plurality of media content based on one or more extracted topics;
wherein the optimal amount of participants relates to distribution of the aggregated media content corresponding to segments based on at least one resource metric of the plurality of resource metrics.

18. The computer system of claim 15, wherein the plurality of resource metrics comprise one or more of power-source levels, network bandwidth, and computing resource availability.

19. The computer system of claim 15, wherein the program instructions to generate the virtual environment further comprise:
program instructions to generate a user profile associated with the at least one participant of the virtual collaboration;
program instructions to determine a level of effectiveness of the plurality of media content within the virtual collaboration for the at least participant; and
program instructions to rank the one or more extracted topics based on the level of effectiveness.

20. The computer system of claim 15, wherein the program instructions to generate the virtual environment further comprise:
program instructions to utilize one or more outputs of at least one machine learning model to determine distribution of a plurality of resources associated with one or more avatars of the virtual environment representing one or more participants of the virtual collaboration.
